(19) United States
(12) Patent Application Publication
(10) Pub. No.: US 2003/0079556 A1
(43) Pub. Date: May 1, 2003

(54) System and method for testing a multilayer preform

(76) Inventors: Mario Sanchez, Frankfort, IL (US); Marion Grabowski, Lemont, IL (US)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/022,141

(22) Filed: Oct. 30, 2001

(51) Int. Cl. G01N 1/04

(52) U.S. Cl. 73/864.41; 83/919

(57) ABSTRACT

A system for facilitating sampling of a multilayer preform includes a cutting tool and a work holder for holding a multilayer preform in a fixed position with respect to the work holder. The work holder is preferably constructed and arranged so as to define first and second tool guides for guiding a pair of spaced, parallel cutting tools in order to providing cut a precise longitudinally oriented sample from the multilayer preform while it is clamped in place by the work holder. A method of sampling a multilayer preform is also disclosed.

### BACKGROUND OF THE INVENTION

1. Field of the Invention

This invention relates broadly to the field of packaging, and, in particular, blow molded plastic containers. More specifically, this invention relates to an improved system and method for testing a multilayer preform for quality control purposes during development and manufacturing.

2. Description of the Related Technology

A high percentage of the plastic containers that are made today are manufactured using the stretch blow molding process. This involves first heating a preshaped, tubular plastic preform or parison, longitudinally stretching the preform or parison, and subsequently inflating the soft preform or parison within a mold cavity that is shaped according to the desired final shape of the container. As the preform is inflated, it takes on the shape of the mold cavity. The polymer quickly solidifies upon contacting the cooler surface of the mold, and the finished hollow container is subsequently ejected from the mold.

Containers for packaging certain foods and beverages idly require such characteristics as low oxygen and moisture permeability, compatibility with the temperatures and pressures encountered in conventional food processing and sterilization, and an impact resistance and rigidity that is sufficient to withstand shipping, warehousing, and abuse. In order to provide containers having these characteristics, the industry is turning increasingly to multilayer packaging technology. For example, a container may be formed from a preform that has inner and outer layers of polyethylene terephthalate (“PET”) in addition to a barrier layer between the inner and outer layers that might have low oxygen permeability. When the preform is blown into a final product these layers would be expected to stay intact, thereby providing a modicum of oxygen impermeability to the final product.

In order to ensure that each of the component layers of a multilayer preform remains intact and unbreached during the molding process the material, the thickness and the positioning of the respective layers on the preform must be designed and manufactured as precisely as possible. In order to practice and enforce appropriate quality control procedures, multilayer preforms should ideally be sampled and inspected in the manufacturing facility as frequently as possible. Unfortunately, proper sampling and inspection of the preform requires either expensive and complex nondestructive testing equipment or requires a number of precise cuts to be made in predetermined locations in the preform. Ideally, at least one of these cuts should be a longitudinal cut that is parallel to the longitudinal axis of the preform, so that the depth and integrity of each of the component layers may be inspected along the entire length of the preform. In fact, more than one such longitudinal cut is advisable, but in practice is difficult to perform.

A need exists for an improved system and method for sampling and testing a multilayer preform that is more efficient, safe and precise than systems and methods that have been used for such sampling and testing in the past.

### SUMMARY OF THE INVENTION

Accordingly, it is an object of the invention to provide an improved system and method for sampling and testing a multilayer preform that is more efficient, safe and precise than systems and methods that have been used for such sampling and testing in the past.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of a system for testing a multilayer preform that is constructed according to a preferred embodiment of the invention;

FIG. 2 is a perspective view of the system shown in FIG. 1, depicting one step in a method that is performed according to the preferred embodiment of the invention;

FIG. 3 is a perspective view depicting a second step in the method that is depicted in FIG. 2; and

FIG. 4 is a perspective view depicting pieces of a preform that have been cut and sampled according to the preferred embodiment of the invention.

### DETAILED DESCRIPTION OF THE PREFERRED EMBODIMENT(S)

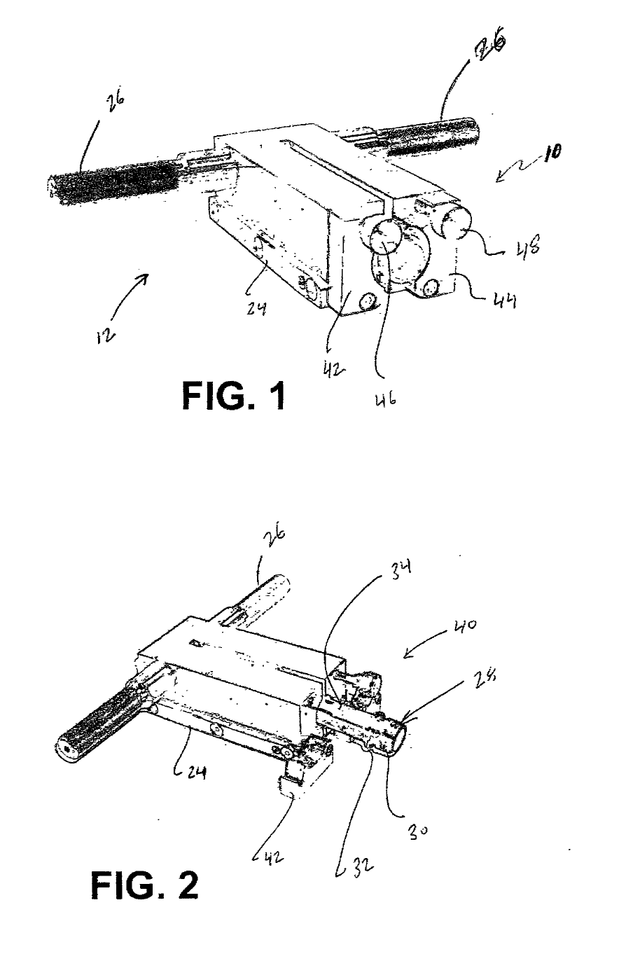

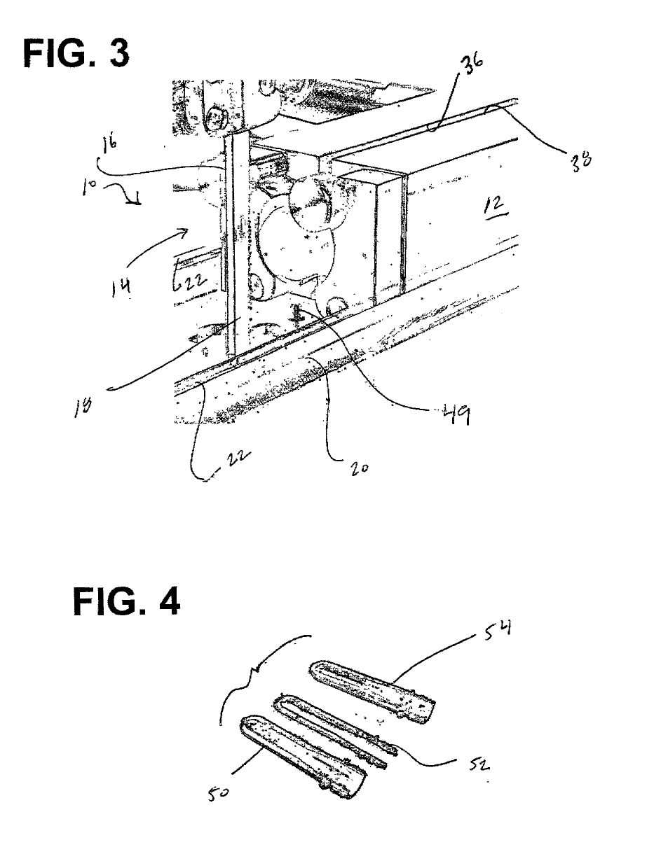

Referring now to the drawings, wherein like reference numerals designate corresponding structure throughout the views, and referring in particular to FIGS. 1 and 3, a system 10 for facilitating sampling of a multilayer preform according to a preferred embodiment of the invention includes a work holder 12 and a cutting tool 14 which includes a first cutting mechanism for cutting a first path through the multilayer preform and a second cutting mechanism for cutting a second path through the multilayer preform. In the preferred embodiment, the first and second cutting mechanisms are both mechanical saws, such as a scroll saw, and the first cutting mechanism is embodied as a first blade 16 and the second cutting mechanism is embodied as a second blade 18.

Referring again to FIG. 3, it will be seen that cutting tool 14 further preferably includes a support surface 20 having a pair of removable longitudinal guide rails 22 that are spaced to slidingly engage side surface elements 24 on the work holder 12 so as to constrain the work holder 12 for longitudinal movement with respect to the cutting tool 14. Work holder 12 further includes a pair of handles 26 that may be gripped by an operator in order to move the work holder 12 with respect to the cutting tool 14 during operation.

As may best be seen in FIG. 2, a multilayer preform 28 includes a threaded finished portion 30 that further includes a circumferential projection 32. Preform 28 further includes a main body portion 34 that is substantially cylindrical in shape, with a radiused distal end portion.

Looking again to FIG. 3, work holder 12 is further constructed and arranged so as to define a first tool guide 36 for guiding the first blade 16 during operation and a second tool guide 38 for similarly guiding the second blade 18 during operation. Both the first and second tool guides 36, 38 are oriented so as to be substantially parallel to each other and to a longitudinal center axis of the preform 28 during operation. As may be seen in FIG. 2, work holder 12 further includes a clamping mechanism 40 that is in the preferred embodiment constructed as a first clamping mechanism 42 and a second clamping mechanism 44. Both the first and second clamping mechanisms 42, 44 are mounted so as to pivot with respect to the main body of the work holder 12 and include clamping surfaces that include a recess that is complementary to the circumferential projection 32 on the finish portion 30 of the preform 28. A first clamping bolt 46 is provided to secure the first clamping member 42 in a closed position during operation, and a second clamping bolt 48 is similarly provided for securing the second clamping member 44 in the closed position during operation. When the clamping mechanism is closed, as is depicted in FIG. 1 and in FIG. 4, the preform 28 will be securely clamped within the work holder 12.

It will be appreciated that the work holder 12 may be constructed in any one of a plurality of different sizes, so as to correspond to the individual preform finish sizes, (i.e.. 24, 28, 33,38,43, 48 mm) available today in the PET beverage market.

In operation, an operator will select a multilayer preform 28 for testing or quality control sampling and will place the preform 28 into the work holder 12, as shown in FIG. 2. Clamping mechanism 40 will then be secured, as is shown in FIGS. 1 and 4. The cutting tool 14 will then be activated, causing the first and second blades 16, 18 to move. The operator will then slide the work holder 12 along the support surface 20 between the guide rails 22, and the first and second blades 16, 18 will respectively be guided by the first and second guides 36, 38 to make precise longitudinally oriented cuts along the entire length of the preform 28. In order to avoid engagement between the cutting tool 14 and the metal surface of the work holder 12 at the end of the first and second guides 36, 38, a stop pin 49 may be provided on the support surface 20 for engaging a forward lower edge of the work holder 12. At this point, the operator will pull the work holder 12 back to a position where it is disengaged from the cutting tool 14 and will remove at least a portion of the cut preform 28 from the work holder 12. As is shown in FIG. 4, the cut preform 28 will have a first side portion 50, a central longitudinal sampling portion 52 and a second side portion 54. It is anticipated that the central longitudinal sampling portion 52 will be the most appropriate portion for quality control testing due to the location of the cut and the shape of the portion, but any or all of the pieces may be further inspected and tested to determine manufacturing variance and other important criteria.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A system for facilitating sampling of a multilayer preform, comprising:
a cutting tool; and
work holder means for holding a multilayer preform in a fixed position with respect thereto, said work holder means being constructed and arranged so as to define at least a first tool guide for guiding said cutting tool during relative movement between said cutting tool and said work bolder means in order to cut said multilayer preform along a predetermined sampling path.

2. A system according to claim 1,further comprising releasable clamping means for tightly securing the multilayer preform within said work holder means during operation.

3. A system according to claim 2, wherein said releasable clamping means is constructed and arranged to engage a finish portion of the multilayer preform.

4. A system according to claim 3,wherein the releasable clamping means is further constructed and arranged to engage a circumferential projection that is part of a finish portion of the multilayer preform.

5. A system according to claim 1, wherein said cutting tool comprises a first cutting mechanism for cutting a first path in the multilayer preform and a second cutting mechanism for cutting a second path in the multilayer preform.

6. A system according to claim 5, wherein said work holder means is further constructed and arranged so as to define a second tool guide, whereby said first tool guide will be positioned to guide said first cutting mechanism and said second cutting guide will be positioned to guide said second cutting mechanism.

7. A system according to claim 1, wherein said cutting tool comprises a mechanical saw.

8. A system according to claim 7,wherein said mechanical saw comprises a first cutting blade and a second cutting blade that is mounted in a spaced parallel relationship to said first cutting blade.

9. A system according to claim 1,wherein said work holder means is constructed and arranged so that said first tool guide is positioned to guide the cutting tool so as to cut the multilayer preform in a direction that is substantially parallel to its longitudinal axis.

10. An apparatus for holding a multilayer preform in a fixed position during sampling, comprising:
means defining a recess for receiving at least part of a main body portion of the multilayer preform during sampling;
releasable clamping means for tightly securing the multilayer preform in position during sampling; and
first guide means for guiding a cutting tool during relative movement between the cutting tool and the apparatus in order to cut the multilayer preform along a predetermined sampling path.

11. An apparatus according to claim 10, wherein said releasable clamping means is constructed and arranged to engage a finish portion of the multilayer preform.

12. An apparatus according to claim 11, wherein the releasable clamping means is further constructed and arranged to engage a circumferential projection that is part of a finish portion of the multilayer preform.

13. An apparatus according to claim 10, further comprising second guide means for guiding a second cutting tool during relative movement between the cutting tool and the apparatus.

14. An apparatus according to claim 13, wherein said second guide means is substantially parallel to said first guide means.

15. An apparatus according to claim 10, wherein said first guide means is substantially parallel to a longitudinal axis of the multilayer preform when the multilayer preform is secured within said recess during sampling.

16. A method of sampling a multilayer preform, comprising steps of:
(a) securing a multilayer within a work holder that includes at least a first tool guide;
(b) cutting the multilayer preform by providing relative movement between the work holder and a first tool such that the first tool is guided by the first tool guide;
(c) removing at least a portion of the cut multilayer preform from the work holder; and
(d) analyzing the portion of the multilayer preform for quality control purposes.

17. A method according to claim 16, wherein the work holder further includes a second tool guide and further comprising a step of making a second cut in the multilayer preform by providing relative movement between the work holder and a second tool such that the second tool is guided by the second tool guide.

18. A method according to claim 17, wherein said step of making a second cut is performed substantially simultaneously with step (b).
